(19) United States
(12) Patent Application Publication
(10) Pub. No.: US 2005/0164876 A1
(43) Pub. Date: Jul. 28, 2005

(54) Photocatalyst and methods of making such

(75) Inventors: Shun-Cheng Lee, Hong Kong SAR (HK); Chio-Hang Ao, Hong Kong SAR (HK)

Correspondence Address: BURNS DOANE SWECKER & MATHIS L L P, POST OFFICE BOX 1404, ALEXANDRIA, VA, 22313-1404, US

(73) Assignee: The Hong Hong Polytechnic University, a university of Hong Kong, Hung Hom (CN)

(21) Appl. No.: 10/765,118

(22) Filed: Jan. 28, 2004

(51) Int. Cl. B01J 31/00

(52) U.S. Cl. 502/159; 502/103

(57) ABSTRACT

The conversion efficiency of existing photocatalysts may decrease with increasing humidity level. The photocatalyst of this invention is made be first mixing an alcohol, a titanium alkoxide and a binder in the presence of a catalytic acid to form a mixture. This mixture is then heated at about 100° C. for at least 2 hours, and then calcinated at about 450° C. for at least 2 hours. The resulting catalyst is found to have improved efficacy at high humidity level.

### FIELD OF THE INVENTION

This invention relates to method for manufacturing photocatalyst, particularly those for removing indoor pollutants such as carbon monoxide (CO), nitrogen oxides (NOx) and volatile organic compounds (VOCs).

### BACKGROUND OF THE INVENTION

Indoor pollutants such as carbon monoxide (CO), nitrogen oxides (NOx) and volatile organic compounds (VOCs) are common and cause adverse health effects. Traditional remediation techniques such as adsorption and filtration may not be suitable and cost-effective for such low concentration pollutants. These filters, without adequate replacement, could even become a source of VOCs in a ventilation system. A new approach is therefore necessary to reduce the pollutant level to maintain a clean environment for good human health.

Photocatalysts developed by the sol-gel method and the addition of rare earth oxides have received much attention. However, the conversion efficiency of existing photocatalysts, like the commercial TiO2 (P25), may decrease with increasing humidity level. Therefore, there may be a need to look for improved photocatalysts that can work satisfactorily in a relatively humid environment, like the Southeast Asian region.

### OBJECTS OF THE INVENTION

Therefore, it is an object of this invention to provide a photocatalyst and method of making such that may resolve at least one or more of the problems as set forth in the prior art. As a minimum, it is an object of this invention to provide the public with a useful choice.

### SUMMARY OF THE INVENTION

Accordingly, this invention provides a method of making a catalyst including the steps of mixing an alcohol, a titanium alkoxide, and a binder in the presence of a catalytic acid to form a first mixture. The first mixture is then heated at a temperature at least equal to 100° C. for at least 2 hours to form a second mixture. The second mixture is then calcinated at a temperature at least equal to 450° C. for at least 2 hours to form the catalyst.

Preferably, the alcohol is selected from the group consisting of isopropanol and ethanol.

Alternatively, the titanium alkoxide is selected from the group consisting of titanium isopropoxide and titanium butoxide.

Preferably, the binder is selected from the group consisting of polyethylene 200, polyethylene 400, polyethylene 600 and a mixture of tetraethoxysilane and water.

Optionally, the molar ratio of alcohol:titanium alkoxide:binder is about 1:12:10 to 1:20:10.

Preferably, the catalytic acid is selected from the group consisting of concentrated hydrochloric acid and concentrated nitric acid. More preferably, the catalytic acid is in an amount of 1.3 to 3.6 weight percent with respect to the titanium alkoxide.

This invention also provides a catalyst manufactured by the above methods.

### BRIEF DESCRIPTION OF THE DRAWING

Preferred embodiments of the present invention will now be explained by way of example and with reference to the accompany drawings in which:

FIG. 1 shows X-ray powder diffraction pattern of a photocatalyst T1 manufactured by the method of this invention;

FIG. 2 shows the differential scanning calorimetry diagram of T1;

FIG. 3 shows the conversion of NOₓ at different residence time (200 ppb NO; humidity 2100 ppmv); and

FIG. 4 shows the conversion of NOx at different humidity (200 ppb NO; residence time 3.8 mins).

### DETAILED DESCRIPTION OF THE PREFERRED EMBODIMENT

This invention is now described by way of example with reference to the figures in the following paragraphs. List 1 is a part list so that the reference numerals in the figures may be easily referred to.

Objects, features, and aspects of the present invention are disclosed in or are obvious from the following description. It is to be understood by one of ordinary skill in the art that the present discussion is a description of exemplary embodiments only, and is not intended as limiting the broader aspects of the present invention, which broader aspects are embodied in the exemplary constructions.

It is found that, surprisingly, when a titanium alkoxide is mixed with an alcohol in the presence of a binder and an acid as catalyst, photocatalysts with improved conversion efficiency (with respect to existing photocatalyst) in relatively humid environment may result. The alcohol, titanium alkoxide, and the binder is mixed and stirred together with a catalytic acid for a period of time to form a first mixture. The first mixture is then heated at an elevated temperature for an extended period of time to form a second mixture. Finally, the second mixture is calcinated at a high temperature for a period of time.

Alcohols suitable to this invention may include isopropanol and ethanol. The alcohol should be capable to dissolve the titanium alkoxide and the binder. Preferably, the alcohol can vaporize at room temperature. Upon addition of alcohol to the alkoxide, there will be ligand exchange between the alkoxide and the alcohol. Alcohols having high molecular weight, for example 1-Octanol, may not be due to slow ligand exchange.

With regard to the titanium alkoxide, titanium isoproxide or titanium butoxide can be used. Other titanium alkoxide, like titanium ethoxide, may be used, provided that they are soluble in the alcohol and allow the hydrolysis, condensation, consolidation of the sol-gel solution or the first mixture.

The function of the binder is to form a part of ligand within the giant structure of the molecule inside the solution. The binder molecule should react to form volatile compounds upon heating, like carbon dioxide and water, leaving a pore within the structure. Thus, the surface area of the resultant molecule increased. Polyethylene 200, polyethylene 400, polyethylene 600 and a mixture of tetraethoxysilane and water are a non-exhaustive list of suitable binders.

The ratio of titanium alkoxide:alcohol:binder is about 1:12:10 to 1:20:10. This molar ration among the components may have a certain degree of freedom. For Example, the amount of titanium alkoxide may be increased to prevent the precipitation of hydrated titanium alkoxide.

The catalytic acid can be concentrated hydrochloric acid or nitric acid. The function of the catalytic acid is to provide the proton required promoting the reaction, and therefore, other acids may be used. The catalytic acid may present in an amount of 1.3 to 3.6 weight percent with respect to the titanium alkoxide.

A first mixture is formed after mixing the alcohol, titanium alkoxide, binder, and catalytic acid. The first mixture is then heated for a period of time, say 2 hours, to complete the reaction between the alcohol, titanium alkoxide, binder so that a second mixture is formed. The heating time of 2 hours is merely an example, as such is found to be satisfactory. The heating time may be dependent on the temperature used and may vary. It is necessary to heat for sufficient time so that titanium dioxide formed is changed from amorphous to crystalline phase. Longer heating time may be used, but such may not improve the quality of the resulting photocatalyst.

Finally, the second mixture is calcinated for, say 2 hours, to form the photocatalyst. Again, the calcinating time of 2 hours is merely an example, and longer heating time may be used, but such may not improve the quality of the resulting photocatalyst.

Photocatalysts and their properties made by the method of this invention will be illustrated in the following section.

### EXAMPLES

Catalyst Preparation

The catalyst used in this experiment for comparison was Degussa P25, which was commercially available. The catalyst was used as received, without any pretreatment. The catalyst was imposed on a glass fiber filter (Whatman) by dipping it into a TiO2 water suspension for 10 min and then calcinated at 120° C. for 1 h with a temperature gradient of 5.5° C./min.

The preparation of the synthetic photocatalyst (denoted as T1) is as follows: a metal alkoxide solution of titanium isopropoxide (TTIP, Acros) was used as the starting materials. 10 g of TTIP was slowly added at room temperature to a solution of absolute ethanol (EtOH) in a breaker under vigorously stirred for 0.5 h to prevent a local concentration of the TTIP solution. EtOH mixed with nitric acid was added to the solution to promote hydrolysis. Polyethylene glycol (PEG, Acros) 600 was added to the solution and stirred for 1 h. The solution was then ultra sounded for 0.5 h and left for 24 h before being used. The molar ratio of TTIP:EtOH:PEG was 1:15:10, corresponding to 5 wt. % of TiO2 in order to compare the photodegradation using P25. Photocatalyst T1 was immobilized on glass fiber by dip-coating. The glass fiber was loaded into the solution for 30 min and retracted at a rate of 10 mm/s. The glass fiber was dried at 100° C. for 2 h and then calcinated at 450° C. for 2 h at a heating rate of 5.5° C./min in air.

Catalyst Characterization

A Philips E'xpert X-ray diffractometer employing Cu Kα was used to identify the X-ray diffraction (XRD) pattern and the phase presented. An accelerating voltage of 35 kV and a current of 20 mA with a scan rate of 0.05° 2θ/s were used. The crystallite size was calculated by applying the Scherrer formula. Differential scanning calorimetry (DSC) and thermal gravity (TG) analysis was preformed using a NETZSCH instrument. A 10 mg sample was used and the heating rate was 10° C./min in flowing air. The Brunauer-Emmett-Teller (BET) surface area was determined by nitrogen adsorption-desorption isotherm measurements at 77K on a Micromeritics ASAP 2000 nitrogen adsorption apparatus. The samples were degassed at 180° C. before measurement.

Reactor and Experimental

The detailed experimental setup has been reported elsewhere [C. H. Ao, S. C. Lee, C. L. Mak, L. Y. Chan, Appl. Catal. B: Environ., vol. 42, year 2003, pg. 119-129]. A reactor with a volume of 57 1 (40.5 H×50.5 L×28 W cm) with its surface coated by a Teflon film (BYTAC Type AF-21) was used for this study. Illumination was provided by a 6 W UV lamp (Cole-Parmler) which emits a primary wavelength at 365 nm and its intensity was determined by a UV meter (Spectroline DRC-100X). The UV lamp was horizontally placed at the upper part of the reactor, 14 cm from both ends. UV intensity measured in all experiments was 600 μW/cm2. The TiO2 coated filter was supported by a Teflon film and fixed horizontally with a vertical distance of 10 cm between the UV lamp. Stainless steel sampling ports and Teflon tubing were used to connect the reactor and the analytical instruments.

A zero air generator (Thermo Environmental Inc. Model 111) was used to supply the air stream. Desired humidity of the flow was controlled by passing the zero air stream through a humidification chamber. The reactant stream and the zero air stream were connected to a mass flow calibrator (Advanced Pollution Instrumentation Inc. Model 700). The gas streams were mixed by a gas blender and the desired flow was controlled by a mass flow controller inside the calibrator.

After the inlet and the outlet concentration achieved equilibrium (1 h), the UV lamp was turned on and initiated the reaction. The concentration of NO was continuously measured by a Chemiluminescence NO analyzer (Thermo Environmental Instruments Inc. Model 42c), which monitors NO, NO2, and NOx at a sampling rate of 0.7 1/min. CO was monitored by a Gas Filter Correlation CO analyzer (Thermo Environmental Instruments Inc. Model 48) at a sampling rate of 1 l/min. Pre-cleaned Summa canisters were evacuated for VOCs sampling. Constant VOCs sampling time was achieved using a mass flow controller. Samples of VOCs were collected at designated times during the experiment. After collection, the canister sample was first concentrated by a Nutech Cryogenic Concentrator (Model 3550A), and the trapped VOCs were separated and analyzed by Hewlett-Packard Gas Chromatograph (Model HP 6890) and quantified by a Mass Selective Detector (Model HP5973). After analysis, the canister was sequentially evacuated and pressurized with humidified zero air until all compounds detected were smaller than 0.2 ppb. TO-14 (Toxi-Mat-14M Certified Standard (Matheson)) standard gas was analyzed using the GC/MS system seven times at 0.2 ppb to obtain the method detection limits.

Results

Characteristic of the Photocatalyst

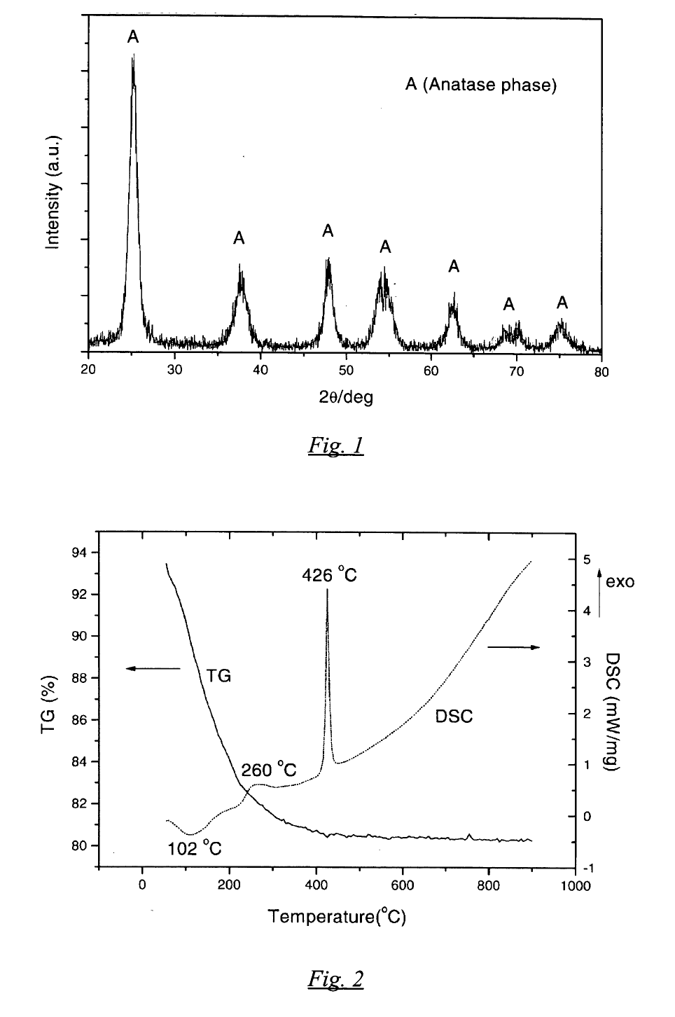

The X-ray diffraction pattern of T1 deposited on glass fiber was too weak for phase identification, FIG. 1 shows the XRD pattern of T1 powders with the same method prepared for T1 deposited on the glass fiber. The pattern was compared with the 21-1272 anatase ASTM card and 21-1276 rutile card. Only the anatase phase was found. Even when the powder was heated to 900° C., no rutile phase and only anatase phase was found. The average crystallite size of T1 and P25 was estimated to be 9.8 and 18.8 nm using the Scherrer equation.

FIG. 2 shows the result of DSC-TG. Two weight loss regions were observed. From room temperature to 260° C., a steep slope is observed and the weight loss corresponds to the desorption of absorbed water and alcohol. From 250° C. and 500° C., a flat slope is observed and the weight loss corresponds to the residual organic and chemisorbed water. From the DSC curve, an exothermic peak was observed to be at 426° C. which corresponded to the crystallization of TiO2 from amorphous phase to anatase phase. The result also agreed with the XRD result and only the anatase phase was observed when the sample was calcinated at 450° C. As with of applying coated TiO2 glass fiber for XRD detection, only powders of T1 with the same preparation was used to identify the BET surface area. The BET surface area of T1 and P25 is 96 and 46 m2/g, respectively.

Photodegradation of NO by Photocatalyst at Different Residence Time

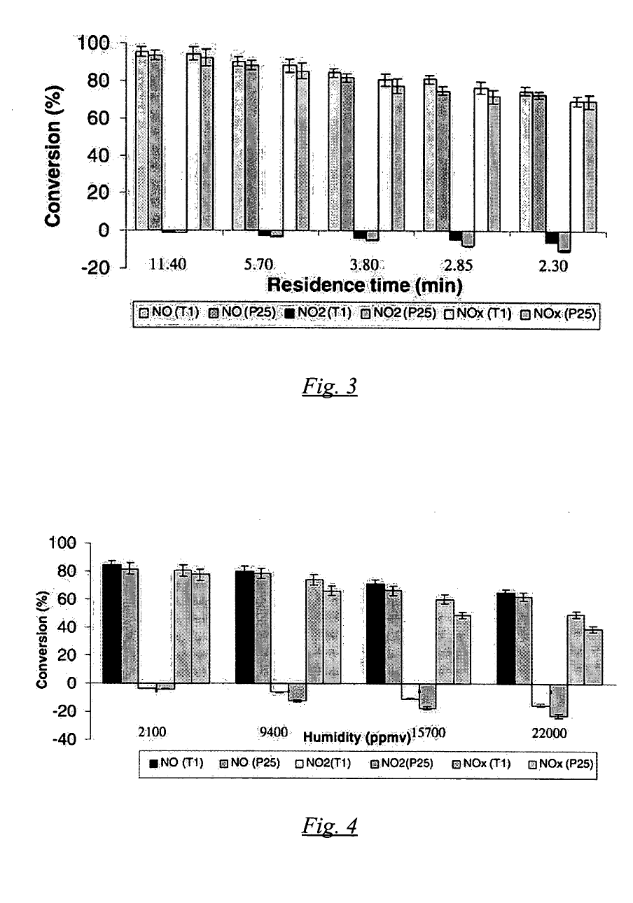

FIG. 3 shows the photodegradation of 200 ppb NO at a humidity level of 2100 ppmv. Each experiment set was conducted four times and the average value was reported. Results showed that the conversion of NOx decreased with decreasing residence time for photocatalyst T1 and P25. The conversion of NOx using photocatalyst T1 and P25 decreased from 94.5 to 70.2% and 92.2 to 69.2% when the residence time decreased from 11.40 to 2.85 min. At a longer residence time, a higher rate of collision frequency between the hydroxyl radicals and the pollutants is expected and therefore the conversion of NOx is also expected to be higher. The higher conversion of NOx using photocatalyst T1 is probably due to a higher BET surface area and a smaller crystal size, although this is a guess with no substantial support at this time. The BET surface area of T1 is nearly double that of P25. Under a low level of humidity, a higher BET surface area provides a larger adsorption site on the catalyst surface for NO to be adsorbed. The result suggested that using EPR spectra, a smaller crystal size would have a more of edges and corner sites for the formation of Ti³⁺ center and form superoxide ions. It can be seen from the XRD data, photocatalyst T1 has a crystal size of 9.8 run which is half the crystal size of P25. It is plausible that the smaller crystal size of T1 contribute the higher conversion of T1.

FIG. 4 shows the photodegradation of 200 ppb NO at a residence time of 3.8 min. The figure that the NOx conversion using photocatalyst T1 and P25 decreased with increasing humidity levels. Note that the affect on T1 is smaller than P25. It is presumed that the larger BET surface area of T1 has a larger adsorption site for the conversion of NO to NO2, with the result that the NO2 concentration exiting the outlet stream is smaller. As the humidity level increased, the conversion difference between T1 and P25 also increased. The increase in the BET surface area successfully improved the conversion of NOx under the current experimental conditions. As discussed in the previous section, the smaller crystal size may also affect the conversion of NO.

In order to evaluate the vital parameter for higher conversion, T1 was prepared without the addition of PEG 600 (denoted as T2). T2 has a similar crystal size of 10.2 nm and a BET surface area of 37 m2/g.

Photodegradation of NO and BTEX with Photocatalyst T1, T2, and P25

The effect of crystal size and BET surface area was investigated to identify the vital parameters for photodegradation of NO at ppb level. Table 1 summarizes the characteristics of the photocatalyst conducted in this study.

As shown in Table 2, the NO conversion of T2 under different residence time is lower than T1 and P25. This is probably due to the lower BET surface area of the photocatalyst T2. T2 has a BET surface area of 37 m2/g, which is smaller than T1 and P25. The difference in NO conversion, however, is not significant, as the BET surface area of T2 is only slightly smaller than P25. The results of a comparison of photocatalysts T1 and T2, indicated that the difference between NO conversion was larger and a fact that can be attributed to larger BET surface area. Table 3 shows the conversion of NO under different levels of humidity. The conversion of NO also follows this trend, with respect to the BET surface area of the photocatalyst, in the following order: T1>P25>T2. Under high levels of humidity, the competition effect of water vapor indicated the significant effect of the BET surface area. Table 4 shows the photodegradation of BTEX at an initial concentration of 35 ppb and a residence time of 3.8 min. Photocatalyst T1 has a higher conversion of benzene and toluene of 10 and 6% compared to that of P25. No significant improved activity for ethylbenzene and o-xylene, however, was observed at humidity 2100 ppmv. Two reasons possibly account for this. Firstly, BTEX adsorbed a different amount on TiO2. The higher BET surface area of T1 provided a larger surface adsorption site, despite the effect of a combination of low-level humidity plus the result of the competition between BTEX and water vapor. The conversion for benzene and toluene were thus improved. Secondly, the reaction rate of hydroxyl radicals of ethylbenzene and o-xylene is comparatively higher than benzene and toluene. The high conversion of ethylbenzene and o-xylene under the current experiment conditions might hinder the improved activity of T1.

The improved activity of T1 is more significant at a high level of humidity. The conversion of BTEX using photocatalyst T1 compared to P25 is even higher (Table 5). The conversion of BTEX is significantly reduced when the humidity level was 22000 ppmv. The extra BET surface of T1 provided more active sites for the adsorption of BTEX. It is noted that owing to the competition of water vapor for active sites, not only the conversions of benzene and toluene were improved but also those of ethylbenzene and o-xylene. The effect of crystal size is not significant under the current experimental conditions. Although T2 has a smaller crystal size (10.2 nm) than that of P25 (18.8 nm), T2 has a lower NO and BTEX conversion than that of P25.

As shown above, a photocatalyst with improved efficacy may be resulted with the methods of this invention. The improvement may be resulted from increased BET surface area of the photocatalyst of this invention.

While the preferred embodiment of the present invention has been described in detail by the examples, it is apparent that modifications and adaptations of the present invention will occur to those skilled in the art. Furthermore, the embodiments of the present invention shall not be interpreted to be restricted by the examples or figures only. It is to be expressly understood, however, that such modifications and adaptations are within the scope of the present invention, as set forth in the following claims. For instance, features illustrated or described as part of one embodiment can be used on another embodiment to yield a still further embodiment. Thus, it is intended that the present invention cover such modifications and variations as come within the scope of the claims and their equivalents.

TABLE 1

| | Crystal | | BET surface |
|---|---|---|---|
| Photocatalyst | size (nm) | Crystal phase | area (m²/g) |
| T1 | 9.8 | Anatase | 96 |
| T2 | 10.2 | Anatase | 37 |
| P-25 | 18.8 | Anatase & rutile | 46 |

TABLE 2

| | Conversion (%) | | | | | | | | |
|---|---|---|---|---|---|---|---|---|---|
| Residence | NO | NO | NO | NO₂ | NO₂ | NO₂ | NOₓ | NOₓ | NOₓ |
| time (min) | (T1) | (T2) | (P25) | (T1) | (T2) | (P25) | (T1) | (T2) | (P25) |
| 11.40 | 95.50 | 92.10 | 93.50 | −1.02 | −1.87 | −1.35 | 94.48 | 90.23 | 92.15 |
| 5.70 | 90.23 | 87.27 | 88.33 | −2.18 | −2.63 | −2.95 | 88.05 | 84.64 | 85.35 |
| 3.80 | 84.17 | 80.36 | 81.65 | −3.63 | −4.33 | −4.87 | 80.54 | 76.03 | 77.45 |
| 2.85 | 80.88 | 73.58 | 74.75 | −4.20 | −8.50 | −7.99 | 76.68 | 65.08 | 71.95 |
| 2.30 | 75.78 | 72.28 | 72.75 | −5.61 | −12.29 | −10.29 | 70.18 | 59.99 | 69.20 |

TABLE 3

| | Conversion (%) | | | | | | | | |
|---|---|---|---|---|---|---|---|---|---|
| Humidity level | NO | NO | NO | NO₂ | NO₂ | NO₂ | NOₓ | NOₓ | NOₓ |
| (ppmv) | (T1) | (T2) | (P25) | (T1) | (T2) | (P25) | (T1) | (T2) | (P25) |
| 2100 | 84.17 | 73.08 | 81.65 | −3.63 | −6.22 | −4.2 | 80.54 | 66.86 | 77.45 |
| 9400 | 80.23 | 70.94 | 78.65 | −6.22 | −17.51 | −12.4 | 74.01 | 53.43 | 66.25 |
| 15700 | 71.08 | 62.76 | 66.45 | −10.76 | −24.13 | −17.45 | 60.32 | 38.63 | 49.00 |
| 22000 | 64.98 | 50.99 | 62.25 | −15.36 | −28.97 | −22.95 | 49.62 | 22.02 | 39.30 |

TABLE 4

| | |
|---|---|
| Experimental | Conversion (%) |

| conditions | Photocatalyst | B | T | E | X |
|---|---|---|---|---|---|
| Humidity | T1 | 37.4 | 62.8 | 72.1 | 75.2 |
| 2100 ppmv | T2 | 27.2 | 52.1 | 66.1 | 69.5 |
| | P-25 | 29.3 | 56.7 | 69.3 | 72.1 |
| Humidity | T1 | 20.6 | 22.8 | 27.4 | 30.7 |
| 22000 ppmv | T2 | 5.3 | 6.1 | 13.2 | 15.9 |
| | P-25 | 8.1 | 9.5 | 13.6 | 18.9 |

Retention time = 3.8 min,
Initial conc. of BTEX = 35 ppb BTEX
B = Benzene
T = Toluene
E = Ethylbenzene
X = o-xylene

TABLE 5

| | Initial | | | |
|---|---|---|---|---|
| | concentration | | Conversion | |
| | | NO | (%) | |
| Experimental conditions | CO (ppm) | (ppb) | CO | NO |
| Humidity 2100 ppmv; R.T. 11.4 min | 2 | 0 | 0 | 0 |
| Humidity 22000 ppmv; R.T. 3.8 min | 2 | 0 | 0 | 0 |
| Humidity 2100 ppmv; R.T. 11.4 min | 2 | 200 | 0 | 95.50 |
| Humidity 22000 ppmv; R.T. 3.8 min | 2 | 200 | 0 | 64.98 |

1. A method of making a catalyst including the steps of:
mixing
1) an alcohol;
2) a titanium alkoxide; and
3) a binder
in the presence of a catalytic acid to form a first mixture
heating the first mixture at a temperature at least equal to 100° C. for at least 2 hours to form a second mixture; and
calcinating the second mixture at a temperature at least equal to 450° C. for at least 2 hours.

2. The method of claim 1, wherein the alcohol is selected from the group consisting of isopropanol and ethanol.

3. The method of claim 1, wherein the titanium alkoxide is selected from the group consisting of titanium isopropoxide and titanium butoxide.

4. The method of claim 1, wherein the binder is selected from the group consisting of polyethylene 200, polyethylene 400, polyethylene 600 and a mixture of tetraethoxysilane and water.

5. The method of claim 1, wherein the molar ratio of alcohol:titanium alkoxide:binder is about 1:12:10 to 1:20:10.

6. The method of claim 1, wherein catalytic acid is selected from the group consisting of concentrated hydrochloric acid and concentrated nitric acid.

7. The method of claim 6, wherein the catalytic acid is in an amount of 1.3 to 3.6 weight percent with respect to the titanium alkoxide.

8. A catalyst manufactured by the method of claim 1.

9. A catalyst manufactured by the method of claim 2.

10. A catalyst manufactured by the method of claim 3.

11. A catalyst manufactured by the method of claim 4.

12. A catalyst manufactured by the method of claim 5.

13. A catalyst manufactured by the method of claim 6.

14. A catalyst manufactured by the method of claim 7.
